(19) United States
(12) Patent Application Publication
(10) Pub. No.: US 2026/0166725 A1
(43) Pub. Date: Jun. 18, 2026

(54) METHOD, DEVICE, AND APPARATUS WITH ROBOT ARM TASK SOLVER

(71) Applicant: Samsung Electronics Co., Ltd., Suwon-si (KR)

(72) Inventors: Joonwoo AHN, Suwon-si (KR); Yonggonjong PARK, Suwon-si (KR)

(73) Assignee: Samsung Electronics Co., Ltd., Suwon-si (KR)

(21) Appl. No.: 19/254,279

(22) Filed: Jun. 30, 2025

(30) Foreign Application Priority Data
Dec. 13, 2024 (KR) 10-2024-0186134

(51) Int. Cl. B25J 9/16

(52) U.S. Cl. CPC B25J 9/163; B25J 9/1661

(57) ABSTRACT

A processor-implemented method including learning a policy for a robot arm to imitate an expert robot arm, based on a learning data set for a plurality of reference tasks obtained from the expert robot arm, controlling the robot arm to perform a target task based on the policy, determining whether the robot arm successfully performed the target task based on the policy, and, in response to a failure of the robot arm to perform the target task or the robot arm completing the target task with a low performance outcome compared to a respective reference task of the learning data set, relearning the policy.

### CROSS-REFERENCE TO RELATED APPLICATIONS

This application claims the benefit under 35 USC § 119(a) of Korean Patent Application No. 10-2024-0186134, filed on December 13, 2024, in the Korean Intellectual Property Office, the entire disclosure of which is incorporated herein by reference for all purposes.

### BACKGROUND

### 1. Field

The following description relates to an electronic device and method with robot arm task solving.

### 2. Description of Related Art

Recent advancement of robot technology has led to active studies on the use of robots in daily lives. Accordingly, techniques are being developed to perform various tasks using robot arms. For example, techniques are being developed to perform various tasks by combining robot arms with artificial intelligence models. Imitation learning, reinforcement learning, or other methods may be used with robot arms to perform various tasks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including learning a policy for a robot arm to imitate an expert robot arm, based on a learning data set for a plurality of reference tasks obtained from the expert robot arm, controlling the robot arm to perform a target task based on the policy, determining whether the robot arm successfully performed the target task based on the policy, and, in response to a failure of the robot arm to perform the target task or the robot arm completing the target task with a low performance outcome compared to a respective reference task of the learning data set, relearning the policy.

The relearning the policy may include generating additional learning data based on a ground-truth step with respect to a ground-truth trajectory of the expert robot arm, adding the additional learning data to the learning data set, and relearning the policy based on the learning data set including the additional learning data.

The generating the additional learning data may include, in response to the failure of the robot arm to perform the target task, generating the additional learning data based on whole ground-truth steps included in the ground-truth trajectory of the expert robot arm.

The generating the additional learning data may include, in response to the robot arm performing the target task with a low performance outcome compared to an expert performance of the expert robot arm for the target task, generating the additional learning data based on a respective ground-truth step corresponding a respective flawed step, the flawed step being a cause of the low performance outcome, the low performance outcome being for a trajectory of the robot arm having performed the target task.

The generating the additional learning data further may include determining the flawed step by respectively comparing a plurality of steps divided from the trajectory with a plurality of ground-truth steps divided from the ground-truth trajectory and determining a respective performance of a respective step corresponding to a respective ground-truth step.

The ground-truth trajectory may be divided into a plurality of ground-truth steps based on one or more of a direction, a velocity, and state changes of a gripper of the expert robot arm and the trajectory may be divided into a plurality of steps based on one or more of a direction, a velocity, and state changes of a gripper of the robot arm.

The learning data set may include mapping data generated for each of the plurality of reference tasks, the mapping data may include state information of the expert robot arm before performing a reference task and behavior information of an expert behavior performed by the expert robot arm to solve the reference task, and the mapping data may associate respective behavior information to a current state indicated by the state information.

The mapping data may include data on a plurality of reference steps, the plurality of reference steps being divided based on one or more of a direction, a velocity, and state changes of a gripper of the expert robot arm during the performing of the reference task.

The method may include evaluating a performance of the policy, in response to the performance of the policy being less than a threshold performance, determining whether the robot arm has successfully performed the target task, and relearning the policy until a relearned performance of the policy reaches the threshold performance.

Additional learning data generated for the relearning in response to the failure of robot arm to perform the target task may be different from additional learning data generated for the relearning in response to the robot arm completing the target task with the low performance outcome.

A first size of additional learning data generated for the relearning in response to the failure of the robot arm to perform the target task may be less than a second size of additional learning data generated for the relearning in response to the robot arm completing the target task with the low performance outcome.

First additional learning data generated for relearning in response to the robot arm failing to perform the target task is based on an entirety of the ground-truth trajectory and second additional learning data generated for relearning in response to the robot arm completing the target task with a low performance outcome is based on specific ground-truth steps corresponding to determined flawed steps

In a general aspect, here is provided a processor-implemented method including learning a policy for a robot arm to imitate an expert robot arm, based on a learning data set for a plurality of reference tasks obtained from the expert robot arm, providing the robot arm with a plurality of verification tasks to evaluate a performance of the learned policy, evaluating the performance of the learned policy according to a ratio of verification tasks successfully performed by the robot arm compared to the plurality of verification tasks, based on a control result of the robot arm, and, in response to the learned policy being less than threshold performance and a failure of the robot arm to perform a verification task or the robot arm completing the verification task with a low performance outcome compared to an expert performance of the expert robot arm for the verification task, relearning the policy.

In a general aspect, here is provided an electronic device including processors configured to execute instructions, a memory storing the instructions, and an execution of the instructions configures the processors to learn a policy such for robot arm to imitate an expert robot arm, based on a learning data set for a plurality of reference tasks obtained from the expert robot arm, control the robot arm to perform a target task based on the policy, determine whether the robot arm completed the target task based on the policy, and, in response to a failure of the robot arm to perform the target task or the robot arm completing the target task with a low performance outcome compared to a respective reference task of the learning data set, relearn the policy.

The processors may be further configured to generate additional learning data based on at a ground-truth step with respect to a ground-truth trajectory of the expert robot arm, add the additional learning data to the learning data set, and relearn the policy based on the learning data set including the additional learning data.

The processors may be further configured to, in response to the failure of the robot arm to perform the target task, generate the additional learning data based on whole ground-truth steps included in the ground-truth trajectory of the expert robot arm.

The processors may be further configured to, in response to the robot arm having completing the target task with the low performance outcome, generate the additional learning data based on a ground-truth step corresponding a flawed step, the flawed step being a cause of the low performance outcome, the low performance outcome being for a trajectory of the robot arm having performed the target task.

The processors may be further configured to determine the flawed step by respectively comparing a plurality of steps divided from the trajectory with a plurality of ground-truth steps divided from the ground-truth trajectory and determine a respective performance of a respective step corresponding to a respective ground-truth step.

The ground-truth trajectory may be divided into a plurality of ground-truth steps based on one or more of a direction, a velocity, and state changes of a gripper of the expert robot arm the trajectory may be divided into a plurality of steps based on one or more of a direction, a velocity, and state changes of a gripper of the robot arm.

The learning data set may include mapping data generated for each of the plurality of reference tasks, the mapping data may include state information of the expert robot arm before performing a reference task and behavior information of an expert behavior performed by the expert robot arm to solve the reference task, and the mapping data may associate respective behavior information to a current state indicated by the state information.

Other features and aspects will be apparent from the following detailed description, the drawings, and the claims.

### BRIEF DESCRIPTION OF THE DRAWINGS

FIG. 1 illustrates an example electronic device according to one or more embodiments.

FIG. 2 illustrates an example learning environment according to one or more embodiments.

FIG. 3 illustrates an example method of learning a policy according to one or more embodiments.

FIG. 4 illustrates an example learning data set according to one or more embodiments.

FIG. 5 illustrates an example method of relearning a policy according to one or more embodiments.

FIG. 6 illustrates an example method of relearning a policy according to one or more embodiments.

FIG. 7 illustrates an example method of generating additional learning data according to one or more embodiments.

FIG. 8 illustrates an example method of generating additional learning data according to one or more embodiments.

FIG. 9 illustrates an example method of evaluating performance of a policy according to one or more embodiments.

Throughout the drawings and the detailed description, unless otherwise described or provided, the same or like drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C”, and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

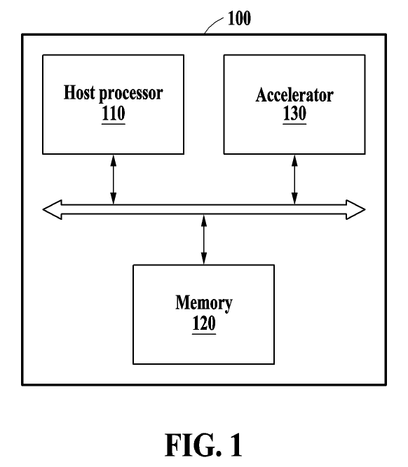

FIG. 1 illustrates an example electronic device according to one or more embodiments.

Referring to FIG. 1, in a non-limiting example, an electronic device 100 may include a processor 110, a memory 120, and an accelerator 130. The processor 110, the memory 120, and the accelerator 130 may communicate with one another via a bus, a network on a chip (NoC), or a peripheral component interconnect express (PCIe). For example, components related to the examples herein are included in the electronic device 100 illustrated in FIG. 1. Thus, the electronic device 100 may also include other general-purpose components in addition to the components illustrated in FIG. 1.

The memory 120 may include computer-readable instructions. The processor 110 may be configured to execute computer-readable instructions, such as those stored in the memory 120, and through execution of the computer-readable instructions, the processor 110 is configured to perform one or more, or any combination, of the operations and/or methods described herein. The memory 120 may be a volatile or nonvolatile memory.

The processor 110 may be configured to execute programs or applications to configure the processor 110 to control the electronic apparatus 100 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples.

In an example, the electronic device 100 may include the accelerator 130 for an operation. As a separate dedicated type of processor, the accelerator 130, may be configured or designed to more efficiently process an operation, due to the characteristics of the operation, than the general-purpose processor 110. In this case, one or more processing elements (PEs) included in the accelerator 130 may be used. For example, the accelerator 130 may be a graphics processing unit (GPU) used for neural network operations such as those involved in model-based methods and tasks.

In an example, the electronic device 100 may control a robot arm. A model-based method and a learning-based method may be used as a method for controlling the robot arm. The model-based method may create an optimal model for performing a single task through modeling but may not readily generate a generalized model for performing various tasks. The learning-based method may perform various tasks through learning using a learning data set without complex modeling but may require an enormous amount of data for learning.

In an example, the electronic device 100 may control the robot arm based on a policy learned for the robot arm to solve a given task. The electronic device 100 may learn the policy of the robot arm to solve a given task. The electronic device 100 may learn the policy of the robot arm by using imitation learning, reinforcement learning, or other learning methods. If there is an expert agent, such as an expert robot arm, that provides expert data (e.g., ground-truth data), then with the expert agent, imitation learning that imitates a behavior of the expert agent (e.g., expert behavior) may be more appropriate for the learning of the policy.

In an example, the robot arm may include a robot arm in a virtual world or a robot arm in a real world. For example, the robot arm may be a virtual robot arm in simulation. The virtual robot arm may be a robot arm in a virtual space that operates through the same mechanism as that of a real-world robot arm. For the virtual robot arm, the electronic device 100 may learn the policy for learning various tasks by using the virtual robot arm. The electronic device 100 taught by the virtual robot arm may then apply the learned policy to a real-world robot arm that the virtual robot arm was based upon. For example, the robot arm may be the real-world robot arm. Thus, with the real-world robot arm, the electronic device 100 may learn the policy for learning various tasks by using the real-world robot arm.

The method of learning the policy of the robot arm by using imitation learning is described in greater detail below.

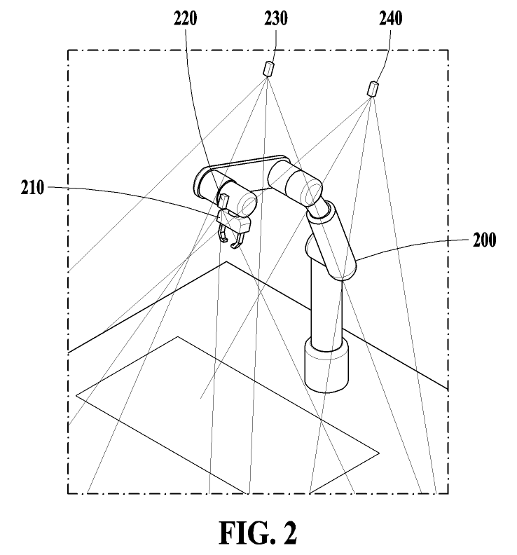

FIG. 2 illustrates an example learning environment according to one or more embodiments.

Referring to FIG. 2, in a non-limiting example, a learning environment for learning a policy and a robot arm 200 is illustrated. The robot arm 200 may be a robot arm in a virtual world or a robot arm in a real world. If the robot arm is a virtual robot arm, the learning environment may be a virtual simulation environment. If the robot arm 200 is a virtual robot arm, the robot arm 200 may be controlled by an electronic device that performs simulations. If the robot arm 200 is a real-world robot arm, the robot arm 200 may be included in the robot arm 200 or may be controlled by an electronic device connected to the robot arm 200.

An end of the robot arm 200 may include a gripper 210. The gripper 210 may grip and move an object. The gripper 210 may enable the robot arm 200 to perform a specified task, such as those involving grasping or gripping items.

The gripper 210 may include an imaging device, such as a camera 220. The camera 220 may be placed on the gripper 210 and may provide precise images of objects interacting with the gripper 210. A plurality of external cameras 230 and 240 of the robot arm 200 may be provided. The plurality of external cameras 230 and 240 may be placed on the right and left sides of the robot arm 200. The plurality of external cameras 230 and 240 may capture a portion of the robot arm 200 and a portion of the learning environment.

Various tasks may be given to the robot arm 200 in the learning environment. For example, tasks, such as a task of moving a box to a specified point, a task of lifting a cup, a task of picking up a knife and putting the knife on a cutting board, a task of putting money in a specified compartment of a safe, a task of pressing a button, and a task of picking up a bottle of wine and putting the bottle of wine in a wine cellar, may be provided.

The method of learning the policy of the robot arm 200 is described in greater detail below.

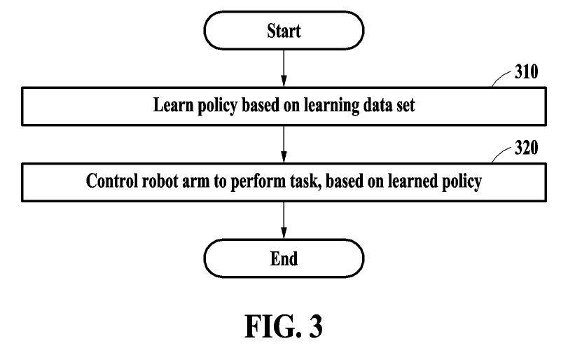

FIG. 3 illustrates an example method of learning a policy according to one or more embodiments.

In the following examples, operations may be performed sequentially but not necessarily. For example, the order of the operations may be changed and at least two of the operations may be performed in parallel. The operations illustrated in FIG. 3 may be performed by at least one component of an electronic device (e.g., electronic device 100).

In an example, in operation 310, the electronic device may learn the policy based on a learning data set.

In an example, the learning data set may be obtained from an expert robot arm. The expert robot arm may be used to be imitated by a robot arm. The expert robot arm may operate based on a model.

When a plurality of reference tasks is provided to the expert robot arm, the expert robot arm may perform the plurality of reference tasks. As the expert robot arm performs the plurality of reference tasks, the learning data set for the plurality of reference tasks may be obtained.

The electronic device may learn the policy such that the robot arm imitates the expert robot arm, based on the learning data set for the plurality of reference tasks obtained from the expert robot arm.

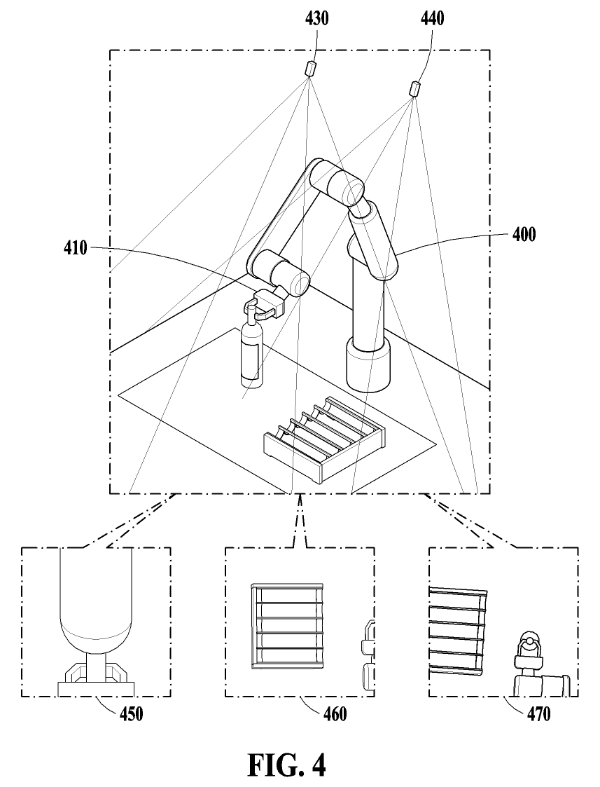

Learning data of the learning data set may include an information pair (e.g., mapping data) that includes state information and behavior information. The state information may indicate a state of the expert robot arm before performing a reference task. The behavior information may indicate a behavior performed by the expert robot arm (i.e., expert behavior) to solve the reference task in the state before performing the reference task. The learning data set is described in greater detail below with reference to FIG. 4.

The electronic device may learn the policy to output the behavior information with the state information as an input.

In an example, in operation 320, the electronic device may control the robot arm to perform a target task based on the learned policy.

If the robot arm is controlled to perform the target task based on the policy which was learned only once according to operation 310, a success rate of the target task may be low. That is, imitation learning uses behavior cloning. Thus, a task may fail to be performed or may be performed sub-optimally, and this situation may not be readily remedied. The suboptimal performance may refer to the task being performed with a low performance compared to the expert robot arm. That is, the task may be completed but with a low performance outcome compared to a desired outcome.

The task may fail to be performed or may be performed sub-optimally because a specified step of a specified task is not sufficiently learned. In addition, there may be situations that are different from situations that were included in the learning data and these different situations have not been learned. In these situations, there may not be responses available for these situations. Finally, there may be errors caused by an accumulation of one or more situations such as situations in which there are no available responses.

The method of obtaining additional learning data to respond to a failure to perform a task or a suboptimal success in performing the task and relearning the task is described in greater detail below.

FIG. 4 illustrates an example learning data set according to one or more embodiments.

Referring to FIG. 4, in a non-limiting example, an expert robot arm 400 is illustrated performing a reference task. For example, the reference task may be a task of picking up a bottle of wine and putting the bottle of wine in a wine cellar. The expert robot arm 400 may perform the reference task in a model-based method.

An electronic device may calculate a trajectory of a gripper 410 at an end of the expert robot arm 400 while the expert robot arm 400 is performing the reference task. The trajectory of the gripper 410 that performs the reference task of the expert robot arm 400 may be referred to as a reference trajectory.

The electronic device may divide the reference trajectory into a plurality of micro-steps. The plurality of micro-steps may include a time-based information pair including state information and behavior information of the gripper 410 obtained from the expert robot arm 400 at certain time intervals (e.g., 0.1 seconds) during the micro-steps or a distance based information pair including state information and behavior information of the gripper 410 obtained from the expert robot arm 400 at a certain increments of motion within every movement (e.g., 1 cm) of the plurality of micro-steps.

The electronic device may divide the reference trajectory into a plurality of reference steps, based on the plurality of micro-steps. The electronic device may determine at least one of direction, velocity, and state changes of the gripper 410, based on the plurality of micro-steps. The electronic device may divide the reference trajectory into the plurality of reference steps, based on at least one of direction, velocity, and state changes of the gripper 410. The electronic device may divide the reference trajectory into the plurality of reference steps, based on at least one of a great change in the direction of the gripper 410, a great change in the velocity of the gripper 410, and the state (e.g., open or close) of the gripper 410.

For example, the electronic device may divide a step if the gripper 410 moves upwardly after moving to the left. For example, the electronic device may divide a step if a variance of the movement velocity of the gripper 410 exceeds a threshold variance. For example, the electronic device may divide a step if the state of the gripper 410 changes from open to close or close to open.

The plurality of reference steps is obtained from the reference trajectory of the gripper 410 of the expert robot arm 400 that performs one reference task and may be sequential. The electronic device may obtain an information pair (e.g., mapping data) of, or including, state information and behavior information when each reference task begins as a data set of the reference task. The state information may include an image 460 obtained from an external camera 430, an image 470 obtained from an external camera 440, and an image 450 obtained from a camera (e.g., camera 220 of FIG. 2) of the gripper 410 when each reference task begins. The behavior information may indicate an expert behavior of the expert robot arm 400 to solve each reference task in the state when each reference task begins. The behavior information may indicate a behavior of the gripper 410 of the expert robot arm 400 to solve each reference task in the state when each reference task begins. For example, the behavior information may include the position (e.g., x, y, or z) of the gripper 410, the direction (e.g., roll, pitch, or yaw) of the gripper 410, and the state (e.g., open or close) of the gripper 410.

The mapping data may include data on the plurality of reference steps divided based on at least one of direction, velocity, and state changes of the gripper 410 of the expert robot arm 400 during the performing of the reference task.

The electronic device may obtain the mapping data where the state information and the behavior information are mapped for each of the plurality of reference tasks. That is, in an example, the mapping data may associate respective behavior information to a current state indicated by the state information. The learning data set may include the mapping data generated for each of the plurality of reference tasks. The electronic device may learn the policy such that a robot arm imitates the expert robot arm 400, based on the learning data set.

The method of determining whether the robot arm controlled based on the learned policy has successfully performed a target task when the target task is provided to the robot arm is described in greater detail below.

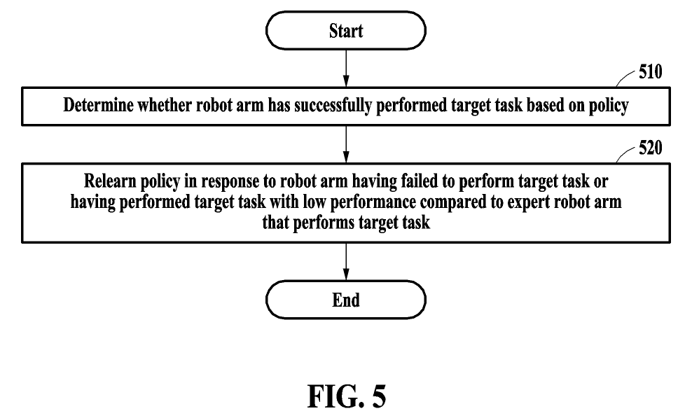

FIG. 5 illustrates an example method of relearning a policy according to one or more embodiments.

In the following embodiments, operations may be performed sequentially but not necessarily. For example, the order of the operations may be changed and at least two of the operations may be performed in parallel. The operations illustrated in FIG. 5 may be performed by at least one component of an electronic device (e.g., electronic device 100).

In an example, in operation 510, the electronic device may determine whether the robot arm has successfully performed the target task based on the policy.

The electronic device may determine the extent to which the robot arm has performed the target task based on the learned policy. For example, if the robot arm has successfully performed the target task based on the learned policy, the electronic device may nonetheless determine that the robot arm performed, or completed, the target task with low performance outcome compared to an expert performance of an expert robot arm that performed the target task.

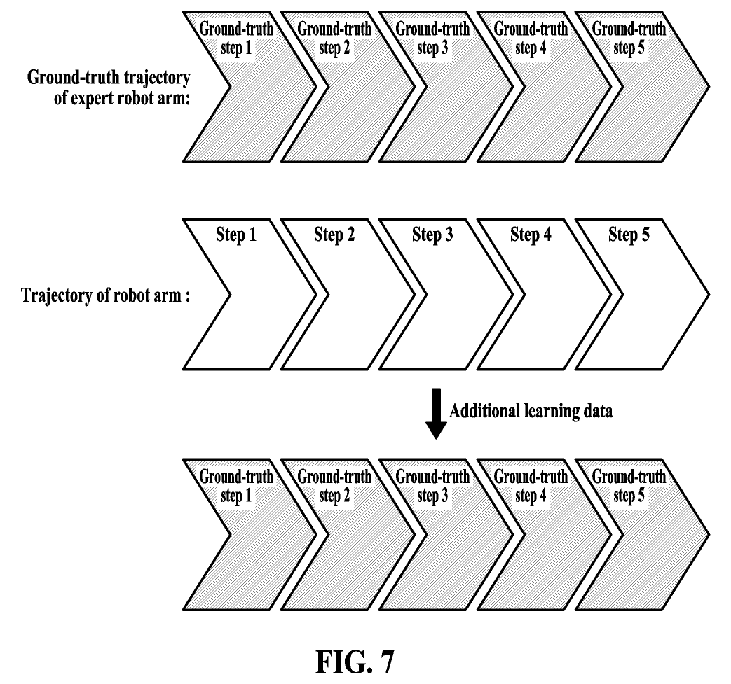

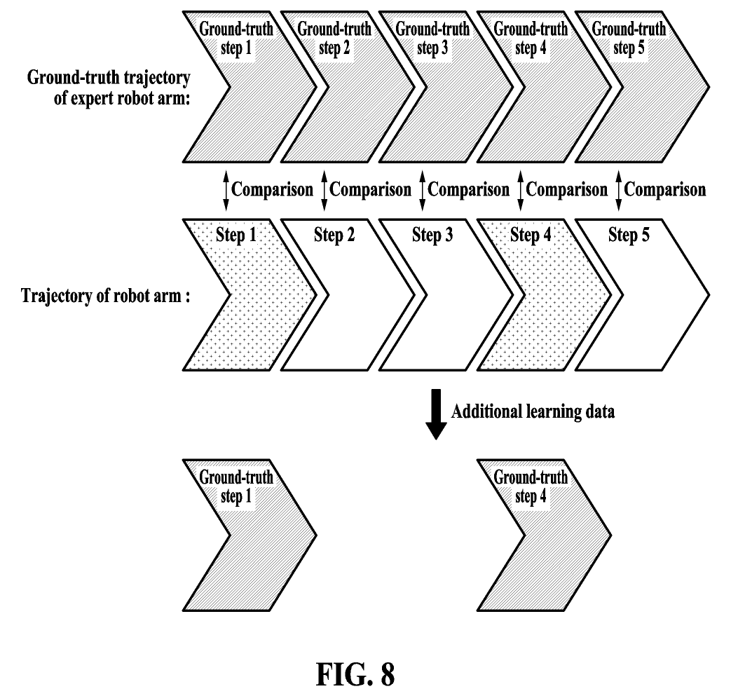

The method of determining whether the robot arm has successfully performed the target task is further described in greater detail below with reference to FIGS. 7 and 8.

In an example, in operation 520, in response to the robot arm having failed to perform the target task or in response to a low performance outcome (i.e., when compared to the expert robot arm’s performance), the electronic device may relearn the policy.

In response to the robot arm having failed to perform the target task or having performed the target task with a low performance outcome, the electronic device may need to learn the policy additionally. In response to the robot arm having failed to perform the target task or having performed the target task with a low performance outcome compared to the expert performance of the expert robot arm for the target task, the electronic device may generate additional learning data.

In these examples, the additional learning data that may be generated for the relearning when the robot arm failed to perform the target task may be different from the additional learning data that may be generated for the relearning in response to the robot arm having performed the target task with a low performance outcome. The additional learning data is described in greater detail below with reference to FIGS. 7 and 8.

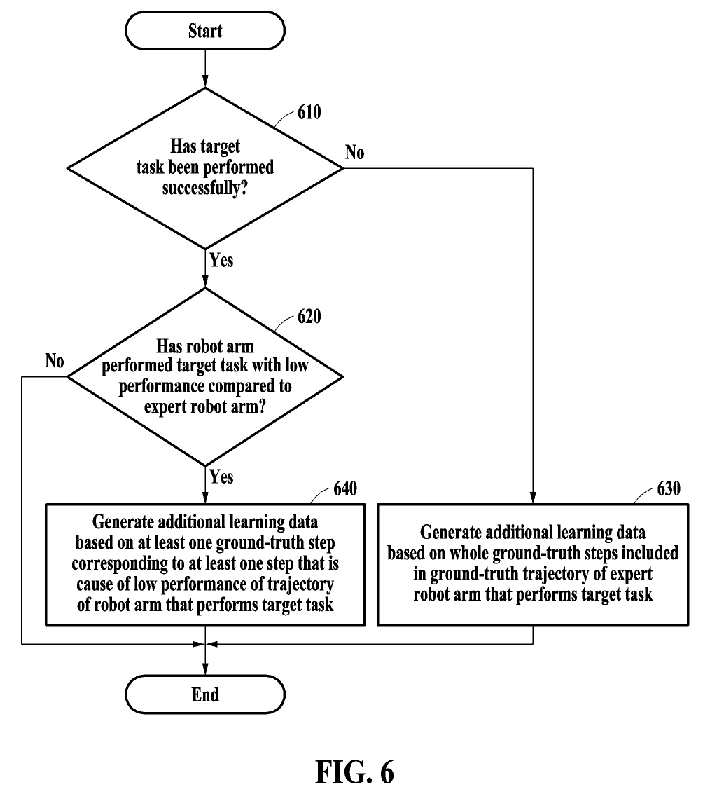

FIG. 6 illustrates an example method of relearning a policy according to one or more embodiments.

In the following embodiments, operations may be performed sequentially but not necessarily. For example, the order of the operations may be changed and at least two of the operations may be performed in parallel. The operations illustrated in FIG. 6 may be performed by at least one component of the electronic device (electronic device 100).

Referring to FIG. 6, in a non-limiting example, in operation 610, the electronic device (e.g., electronic device 100) may determine whether the robot arm has successfully performed the target task.

The success in performing the target task may refer to an accomplishment of the objective of the target task. For example, if the target task is a task of moving a box to a specified point, and the box is moved to the specified point, the objective of the target task may be accomplished. For example, if the target task is a task of lifting an umbrella to a specified height, and the umbrella is lifted to the specified height, the objective of the target task may be accomplished.

In an example, the electronic device may determine that the target task has been failed if a distance between a target position where a target object included in the target task was required to be positioned and a position (such as the target object’s central position) of the target object exceeds a threshold distance from the target position when at a final step of the robotic arm’s performance of the target task. The electronic device may determine that the target task has been successfully performed if the distance between the target position and the position of the target object upon completion of the task by the robot arm (i.e., the final step) is less than or equal to the threshold distance. For example, in a task of lifting an umbrella 50 cm, the electronic device may determine that the target task has been failed if a distance between the target position and a central position of the umbrella, which is the target object, exceeds the threshold distance (e.g., 5 cm) at the final step.

In an example, the electronic device may determine that the target task has been failed if a distance between a target position where a target object is to be positioned by a gripper of the robot arm and a position of the gripper at the final step exceeds the threshold distance. The electronic device may determine that the target task has been successfully performed if the distance between the target position and the final position of the gripper is less than or equal to the threshold distance at the final step of the target task performed by the robot arm.

The electronic device may perform operation 620 if the success in performing the target task is determined in operation 610. The electronic device may perform operation 630 if the failure to perform the target task is determined in operation 610.

In an example, in operation 620, the electronic device may determine whether the robot arm has performed the target task with a low performance outcome compared to the expert robot arm.

The electronic device may obtain a ground-truth trajectory of the expert robot arm that performs the target task. The electronic device may compare a trajectory of the robot arm with the ground-truth trajectory of the expert robot arm while controlling the robot arm to perform the target task. The electronic device may determine whether the robot arm has performed the target task with a low performance outcome by comparing the trajectory with the ground-truth trajectory.

If it is determined that the robot arm has performed the target task with low performance outcome, the electronic device may determine a flawed step that is a cause of a low performance outcome based on the trajectory of the robot arm that performs the target task. For example, there may be one or more flawed steps that are detected or determined to have occurred from among the micro-steps performed by the robot arm. The flawed step may be a step that is incorrectly performed or performed with reduced accuracy or fidelity to a related ground-truth step or step of the expert arm. In addition, a respective flawed step may be responsible for one or more low performance outcomes.

The electronic device may divide the ground-truth trajectory into a plurality of ground-truth steps. The electronic device may divide the ground-truth trajectory into the plurality of ground-truth steps, based on at least one of direction, velocity, and state changes of a gripper of the expert robot arm.

The electronic device may divide the trajectory into a plurality of steps. The electronic device may divide the trajectory into the plurality of steps, based on at least one of direction, velocity, and state changes of the gripper of the robot arm.

The method of dividing the reference trajectory into the plurality of reference steps was described above with reference to FIG. 4 may also apply to the dividing into the plurality of ground-truth steps and the plurality of steps, and thus the detailed description thereof is omitted.

The electronic device may determine which step of the micro-steps performed by the robot arm is the flawed step by comparing a step with a ground-truth step corresponding to the step. The method of determining the flawed step that is a cause of low performance is described in greater detail below with reference to FIG. 8.

In an example, the electronic device may perform operation 640 if it was determined in operation 620 that the robot arm has performed the target task with a low performance compared to the expert robot arm. The electronic device may terminate the operations without requiring additional training if, in operation 620, that the robot arm has performed the target task with an acceptable performance compared to the expert robot arm (i.e., the low performance outcome was not detected).

In an example, in operation 630, the electronic device may generate the additional learning data based on the whole ground-truth steps included in the ground-truth trajectory of the expert robot arm that performs the target task.

With the robot arm failing to accomplish the objective of the target task, an overall learning (e.g., a relearning process or an additional learning process) of the target task may be required. The electronic device may generate the additional learning data based on the whole ground-truth steps included in the ground-truth trajectory.

The method of generating the additional learning data based on the whole ground-truth steps is described in greater detail below with reference to FIG. 7.

In an example, in operation 640, the electronic device may generate the additional learning data based on a ground-truth step corresponding to the flawed step that is a cause of the low performance outcome in the performance of the target task by the robot arm. For example, one or more of the robot arm’s trajectories may have been the source of the low performance outcome. In addition, one or more ground-truth steps may correspond to the flawed step or one or more flawed steps when determining causes for one or more low performance outcomes.

When the robot arm performs the target task with a low performance outcome may result from insufficient optimization for the target task. For optimization, the electronic device may generate the additional learning data based on the ground-truth step corresponding to the flawed step.

The method of generating the additional learning data based on the ground-truth step corresponding to the flawed step is described in greater detail below with reference to FIG. 8.

The electronic device may add the additional learning data to the learning data set. The electronic device may relearn the policy by using the learning data set to which the additional learning data is added.

The generating of the additional learning data is described below.

FIG. 7 illustrates an example method of generating additional learning data according to one or more embodiments.

Referring to FIG. 7, in a non-limiting example, a robot arm that has failed to perform a target task is illustrated. FIG. 7 illustrates a ground-truth trajectory of an expert robot arm that performs the target task and a trajectory of the robot arm.

The ground-truth trajectory of the expert robot arm may be divided into a plurality of ground-truth steps. The trajectory of the robot arm may be divided into a plurality of steps. For example, the ground-truth trajectory may be divided into ground-truth steps 1 to 5. For example, the trajectory may be divided into steps 1 to 5.

If the robot arm has failed to perform the target task, an overall learning of the target task may be required, such as acquiring additional learning data. The electronic device may generate the additional learning data based on the whole ground-truth steps included in the ground-truth trajectory with no need to compare a step with a ground-truth step corresponding to the step because the overall learning of the target task is required.

The additional learning data in the case of failure to perform the target task may include mapping data of each ground-truth step. State information of the expert robot arm at each ground-truth step and behavior information of a behavior performed by the expert robot arm to solve the target task in a state indicated by the state information may be mapped to the additional learning data.

The state information may include images obtained from external cameras and a camera of a gripper when each ground-truth step begins. The behavior information may include a behavior of the expert robot arm to solve the target task when each ground-truth step begins. The behavior information may include a behavior of the gripper of the expert robot arm to solve the target task when each ground-truth step begins. For example, the behavior information may include the position (e.g., x, y, or z) of the gripper, the direction (e.g., roll, pitch, or yaw) of the gripper, and the state (e.g., open or close) of the gripper.

FIG. 8 illustrates an example method of generating additional learning data according to one or more embodiments.

Referring to FIG. 8, in a non-limiting example, a robot arm that has accomplished the objective of the target task but has performed the target task with a low performance outcome is illustrated. In response to the low performance outcome (i.e., when compared to an expert robot arm), an electronic device (e.g., electronic device 100) may determine which step of the micro-steps is the flawed step that is a cause of the low performance outcome. In addition, the electronic device may determine that more than one step of a plurality of steps performed by the robot arm are flawed steps that lead to one or more low performance outcomes.

The ground-truth trajectory of the expert robot arm may be divided into a plurality of ground-truth steps. The trajectory of the robot arm may be divided into a plurality of steps. For example, the ground-truth trajectory may be divided into ground-truth steps 1 to 5. For example, the trajectory may be divided into steps 1 to 5.

In an example, an electronic device (e.g., electronic device 100) may respectively compare the plurality of ground-truth steps divided from the ground-truth trajectory with the plurality of steps divided from the trajectory. The electronic device may determine the flawed step that is a cause of the low performance outcome by determining a step corresponding to a ground-truth step with the ground-truth step as a reference.

In an example, the electronic device may determine the flawed step by comparing behavior information of a step with behavior information of a ground-truth step corresponding to the step. For example, the electronic device may compare the step 1 with the ground-truth step 1 corresponding to the step 1. For example, the electronic device may compare the step 3 with the ground-truth step 3 corresponding to the step 3.

In an example, the electronic device may determine that a difference between a position of a gripper included in the behavior information of a step and a position of a gripper included in the behavior information of a ground-truth step corresponding to the step exceeds a first threshold value.

In an example, the electronic device may determine that a difference between a direction of the gripper included in the behavior information of a step and a direction of the gripper included in the behavior information of a ground-truth step corresponding to the step exceeds a second threshold value.

In an example, the electronic device may determine that a difference between a state (e.g., an angle at which the gripper opens) of the gripper included in the behavior information of a step and a state of the gripper included in the behavior information of a ground-truth step corresponding to the step exceeds a third threshold value.

If the robot arm has accomplished the objective of the target task, but the difference between the positions of the grippers exceeds the first threshold value, the difference between the directions of the grippers exceeds the second threshold value, or the difference between the states of the grippers exceeds the third threshold value, the electronic device may determine that the robot arm has performed the target task with a low performance outcome compared to the expert performance for the target task by the expert robot arm.

The electronic device may determine the flawed step that is a cause of low performance based on the comparison results described above. For example, the step where the difference between the positions of the grippers exceeds the first threshold value, the difference between the directions of the grippers exceeds the second threshold value, or the difference between the states of the grippers exceeds the third threshold value may be determined as the flawed step. For example, the electronic device may determine the steps 1 and 4 as the flawed step.

The electronic device may generate additional learning data based on ground-truth step corresponding to the flawed step that is a cause of the low performance outcome.

The additional learning data generated based on the ground-truth step corresponding to the flawed step may include mapping data of the ground-truth step. State information of the expert robot arm at the ground-truth step and behavior information of a behavior performed by the expert robot arm to solve the target task in a state indicated by the state information may be mapped to the additional learning data.

The state information may include images obtained from external cameras and a camera of a gripper when the ground-truth step begins. The behavior information may include a behavior of the expert robot arm to solve the target task when the ground-truth step begins. The behavior information may include a behavior of the gripper of the expert robot arm to solve the target task when the at least one ground-truth step begins. For example, the behavior information may include the position (e.g., x, y, or z) of the gripper, the direction (e.g., roll, pitch, or yaw) of the gripper, and the state (e.g., open or close) of the gripper.

In an example, the electronic device may determine a specified step as the flawed step if the gripper of the robot arm does not move for a certain time at the specified step. For example, there may be a case where the robot arm has performed the target task but failed to move at an obstacle. The electronic device may determine a specified step as the flawed step if the gripper does not move for a certain time at the specified step or a difference between an actual movement distance and a movement distance of the robot arm based on the learned policy exceeds a threshold distance.

The additional learning data generated for the relearning in response to the robot arm having failed to perform the target task may be based on whole target steps, and the additional learning data generated for the relearning in response to the robot arm having performed the target task with a low performance outcome compared to the expert performance may be based on at least one target step. Accordingly, the size of the additional learning data generated for the relearning in response to the robot arm having failed to perform the target task may be less than the size of the additional learning data generated for the relearning in response to the robot arm having performed the target task with the low performance outcome.

Thus, the electronic device may add the additional learning data to the learning data set. The electronic device may relearn the policy by using the learning data set to which the additional learning data is added.

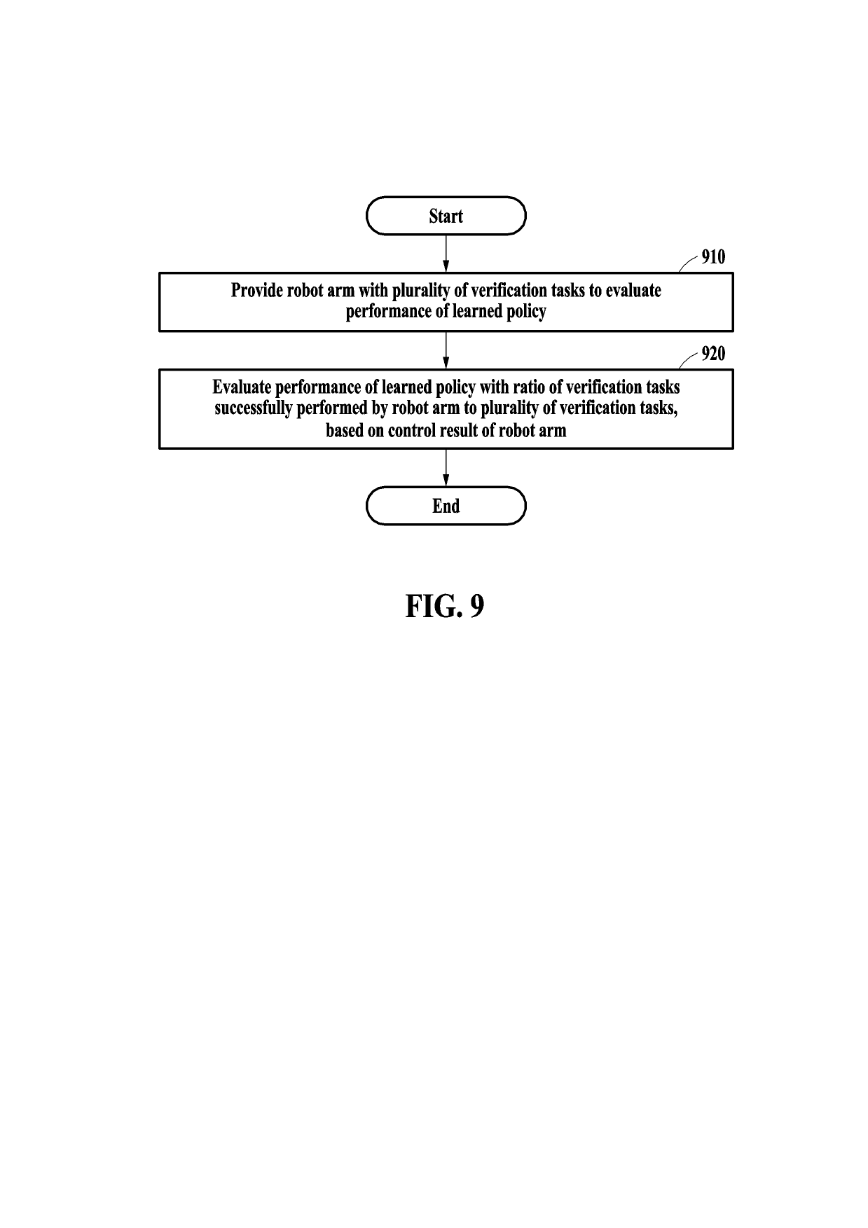

FIG. 9 illustrates an example method of evaluating performance of a policy according to one or more embodiments.

In the following embodiments, operations may be performed sequentially but not necessarily. For example, the order of the operations may be changed and at least two of the operations may be performed in parallel. The operations illustrated in FIG. 9 may be performed by at least one component of an electronic device (e.g., electronic device 100).

Referring to FIG. 9, in a non-limiting example, an operation 910, the electronic device may provide a robot arm with a plurality of verification tasks to evaluate a performance of a learned policy.

In an example, if learning the policy based on a learning data set, the electronic device may further include an operation of evaluating the performance of the learned policy. The electronic device may determine whether to relearn the policy by evaluating the performance of the learned policy.

The plurality of verification tasks may be partially transformed tasks having the same objective as that of a plurality of reference tasks included in learning data. For example, if a reference task is a task of lifting an umbrella 50 cm, and the robot arm begins operation from the right side of the umbrella, a verification task may be the task of lifting the umbrella 50 cm, and the robot arm may begin operation from the left side of the umbrella.

In an example, in operation 920, the electronic device may evaluate the performance of the learned policy with a ratio of verification tasks successfully performed by the robot arm to the plurality of verification tasks, based on a control result of the robot arm.

The electronic device may evaluate the performance of the learned policy based on the control result of the robot arm controlled to perform the plurality of reference tasks.

The electronic device may determine whether the ratio of verification tasks successfully performed by the robot arm to the plurality of verification tasks is less than a threshold ratio (e.g., threshold performance). In response to the performance of the policy being less than the threshold performance, the electronic device may perform the relearning of the policy until the performance of the policy is greater than or equal to the threshold performance. In response to the performance of the policy being less than threshold performance, the electronic device may repeat controlling the robot arm to perform a target task by providing the target task (i.e., relearning the policy until a relearned performance of the policy reaches the threshold performance), determining whether the robot arm has successfully performed the target task, and relearning the policy by generating another piece of additional learning data depending on whether the target task has been successfully performed until the performance of the policy is greater than or equal to the threshold performance. The target task may be any one of the plurality of verification tasks. Alternatively, the target task may be a new task different from the plurality of reference tasks and the plurality of verification tasks.

In an example, the electronic device may learn the policy such that the robot arm imitates an expert robot arm, based on the learning data set for the plurality of reference tasks obtained from the expert robot arm to be imitated by the robot arm. The electronic device may provide the robot arm with the plurality of verification tasks to evaluate the performance of the learned policy. The electronic device may evaluate the performance of the learned policy with a ratio of verification tasks successfully performed by the robot arm to the plurality of verification tasks, based on the control result of the robot arm. In response to the learned policy being less than threshold performance and the robot arm having failed to perform a verification task or having performed the verification task with a low performance outcome compared to the expert performance by the expert robot arm that performed the verification task, the electronic device may relearn the policy.

The electronic devices, memories, processors, accelerators, neural networks, robots, robot arms, electronic device 100, memory 120, processor 110, accelerator 130, robot arm 200, gripper 210, cameras 220, 230, 240, 430, and 440, expert robot arm 400, gripper 410, described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks , and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
learning a policy for a robot arm to imitate an expert robot arm, based on a learning data set for a plurality of reference tasks obtained from the expert robot arm;
controlling the robot arm to perform a target task based on the policy;
determining whether the robot arm successfully performed the target task based on the policy; and,
in response to a failure of the robot arm to perform the target task or the robot arm completing the target task with a low performance outcome compared to a respective reference task of the learning data set, relearning the policy.

2. The method of claim 1, wherein the relearning the policy comprises:
generating additional learning data based on a ground-truth step with respect to a ground-truth trajectory of the expert robot arm;
adding the additional learning data to the learning data set; and
relearning the policy based on the learning data set comprising the additional learning data.

3. The method of claim 2, wherein the generating the additional learning data comprises:
in response to the failure of the robot arm to perform the target task, generating the additional learning data based on whole ground-truth steps comprised in the ground-truth trajectory of the expert robot arm.

4. The method of claim 2, wherein the generating the additional learning data comprises:
in response to the robot arm performing the target task with a low performance outcome compared to an expert performance of the expert robot arm for the target task, generating the additional learning data based on a respective ground-truth step corresponding a respective flawed step, the flawed step being a cause of the low performance outcome, the low performance outcome being for a trajectory of the robot arm having performed the target task.

5. The method of claim 4, wherein the generating the additional learning data further comprises:
determining the flawed step by respectively comparing a plurality of steps divided from the trajectory with a plurality of ground-truth steps divided from the ground-truth trajectory; and
determining a respective performance of a respective step corresponding to a respective ground-truth step.

6. The method of claim 2, wherein the ground-truth trajectory is divided into a plurality of ground-truth steps based on one or more of a direction, a velocity, and state changes of a gripper of the expert robot arm, and
wherein the trajectory is divided into a plurality of steps based on one or more of a direction, a velocity, and state changes of a gripper of the robot arm.

7. The method of claim 1, wherein the learning data set comprises mapping data generated for each of the plurality of reference tasks,
wherein the mapping data comprises state information of the expert robot arm before performing a reference task and behavior information of an expert behavior performed by the expert robot arm to solve the reference task, and
wherein the mapping data associates respective behavior information to a current state indicated by the state information.

8. The method of claim 7, wherein the mapping data comprises data on a plurality of reference steps, the plurality of reference steps being divided based on one or more of a direction, a velocity, and state changes of a gripper of the expert robot arm during the performing of the reference task.

9. The method of claim 1, further comprising:
evaluating a performance of the policy;
in response to the performance of the policy being less than a threshold performance, determining whether the robot arm has successfully performed the target task; and
relearning the policy until a relearned performance of the policy reaches the threshold performance.

10. The method of claim 1, wherein additional learning data generated for the relearning in response to the failure of robot arm to perform the target task is different from additional learning data generated for the relearning in response to the robot arm completing the target task with the low performance outcome.

11. The method of claim 1, wherein a first size of additional learning data generated for the relearning in response to the failure of the robot arm to perform the target task is less than a second size of additional learning data generated for the relearning in response to the robot arm completing the target task with the low performance outcome.

12. The method of claim 1, wherein first additional learning data generated for relearning in response to the robot arm failing to perform the target task is based on an entirety of the ground-truth trajectory, and
wherein second additional learning data generated for relearning in response to the robot arm completing the target task with a low performance outcome is based on specific ground-truth steps corresponding to determined flawed steps.

13. A processor-implemented method, the method comprising:
learning a policy for a robot arm to imitate an expert robot arm, based on a learning data set for a plurality of reference tasks obtained from the expert robot arm;
providing the robot arm with a plurality of verification tasks to evaluate a performance of the learned policy;
evaluating the performance of the learned policy according to a ratio of verification tasks successfully performed by the robot arm compared to the plurality of verification tasks, based on a control result of the robot arm; and,
in response to the learned policy being less than threshold performance and a failure of the robot arm to perform a verification task or the robot arm completing the verification task with a low performance outcome compared to an expert performance of the expert robot arm for the verification task, relearning the policy.

14. An electronic device, comprising:
processors configured to execute instructions; and
a memory storing the instructions, wherein execution of the instructions configures the processors to:
learn a policy such for robot arm to imitate an expert robot arm, based on a learning data set for a plurality of reference tasks obtained from the expert robot arm,
control the robot arm to perform a target task based on the policy,
determine whether the robot arm completed the target task based on the policy, and,
in response to a failure of the robot arm to perform the target task or the robot arm completing the target task with a low performance outcome compared to a respective reference task of the learning data set, relearn the policy.

15. The electronic device of claim 14, wherein the processors are further configured to:
generate additional learning data based on at a ground-truth step with respect to a ground-truth trajectory of the expert robot arm;
add the additional learning data to the learning data set; and
relearn the policy based on the learning data set comprising the additional learning data.

16. The electronic device of claim 15, wherein the processors are further configured to:
in response to the failure of the robot arm to perform the target task, generate the additional learning data based on whole ground-truth steps comprised in the ground-truth trajectory of the expert robot arm.

17. The electronic device of claim 15, wherein the processors are further configured to:
in response to the robot arm having completing the target task with the low performance outcome, generate the additional learning data based on a ground-truth step corresponding a flawed step, the flawed step being a cause of the low performance outcome, the low performance outcome being for a trajectory of the robot arm having performed the target task.

18. The electronic device of claim 17, wherein the processors are further configured to:
determine the flawed step by respectively comparing a plurality of steps divided from the trajectory with a plurality of ground-truth steps divided from the ground-truth trajectory; and
determine a respective performance of a respective step corresponding to a respective ground-truth step.

19. The electronic device of claim 15, wherein the ground-truth trajectory is divided into a plurality of ground-truth steps based on one or more of a direction, a velocity, and state changes of a gripper of the expert robot arm, and
wherein the trajectory is divided into a plurality of steps based on one or more of a direction, a velocity, and state changes of a gripper of the robot arm.

20. The electronic device of claim 14, wherein the learning data set comprises mapping data generated for each of the plurality of reference tasks,
wherein the mapping data comprises state information of the expert robot arm before performing a reference task and behavior information of an expert behavior performed by the expert robot arm to solve the reference task, and
wherein the mapping data associates respective behavior information to a current state indicated by the state information.
